(19) United States
(12) Patent Application Publication
(10) Pub. No.: US 2012/0256341 A1
(43) Pub. Date: Oct. 11, 2012

(54) METHOD FOR GRANULATING PLASTIC HAVING A HIGH SOFTENING TEMPERATURE

(75) Inventor: Frank Gloeckner, Aschaffenburg (DE)

(73) Assignee: AUTOMATIK PLASTICS MACHINERY GMBH, 63762 Grossostheim (DE)

(21) Appl. No.: 13/139,972

(22) PCT Filed: Dec. 15, 2009
(86) PCT No.: PCT/EP09/08996

§ 371 Date: Jun. 25, 2012

(30) Foreign Application Priority Data
Dec. 16, 2008 (DE) 10 2008 062 480.2

(51) Int. Cl. B29B 9/06

(52) U.S. Cl. 264/140; 425/86

(57) ABSTRACT

The invention relates to a method for granulating plastic having a high softening temperature, in particular of above 120° C., using a perforated plate for producing strands of molten plastic and a subsequent process chamber containing a process fluid and including a chopping device, from which a mixture of process fluid and granulate is then discharged into a cooling section for cooling said granulate. The process chamber is filled with a process fluid, in particular water, at a temperature of more than 120° C. and at a pressure of over 2 bar, and the mixture of process fluid and granulate, whose pressure will be maintained as it passes through the cooling section, will then be supplied to a separator in which the granulate, which has first been directed through a pressure lock for bringing it down to ambient pressure, will then be separated from the process fluid and discharged.

### CROSS REFERENCE TO RELATED APPLICATIONS

This is the U.S. National Phase of PCT/EP2009/008996 filed Dec. 15, 2009, which claims priority to German Patent Application No. 10 2008 062 480.2, filed Dec. 16, 2008, each of which are incorporated by reference herein in their entireties.

The invention relates to a method for granulating plastic having a softening temperature of above 120° C., which uses a perforated plate for producing strands of molten plastic and a subsequent process chamber containing a process fluid and including a chopping device, which will discharge a mixture of process fluid and granulate, with said granulate being cooled down in a cooling section. Said process chamber is filled with a process fluid, in particular water, of a temperature of more than 120° C. and at a pressure of over 2 bar, and the mixture of process fluid and granulate, whose pressure is maintained as it passes through the cooling section, is directed into a separator. Said separator will then separate the granulate, which was previously directed through a pressure lock for bringing down its pressure to ambient pressure, from the process fluid and discharge it.

A method of this type and special features thereof are disclosed in U.S. patent application publication no. US 2005/0154183 A1, in the context of processing polyethylene terephthalate.

It is the object of the invention to make this method energy efficient by recovering the thermal energy contained in the process fluid and then using it for the granulating process. According to the invention, this is accomplished by directing the mixture of process fluid and granulate, once it has passed the cooling section, through a heat exchanger where the heat will be recovered and then via the pressure lock on to the separator at a temperature below the boiling point of the process fluid. The separator will then, on the one hand, discharge the granulate and, on the other hand, will return the process fluid to the process chamber via the heat exchanger.

This method is particularly advantageous for use with polycarbonate, a polycarbonate blend, polystyrene, low-viscosity PET.

The chopping device is expediently designed in the manner of an underwater granulator to which the hot plastic strands are supplied via a perforated plate. As these strands exit the perforated plate, they will be chopped up into granulate by a cutting rotor passing over the perforated plate.

Shown in the drawings is an embodiment of the invention. In the drawings,

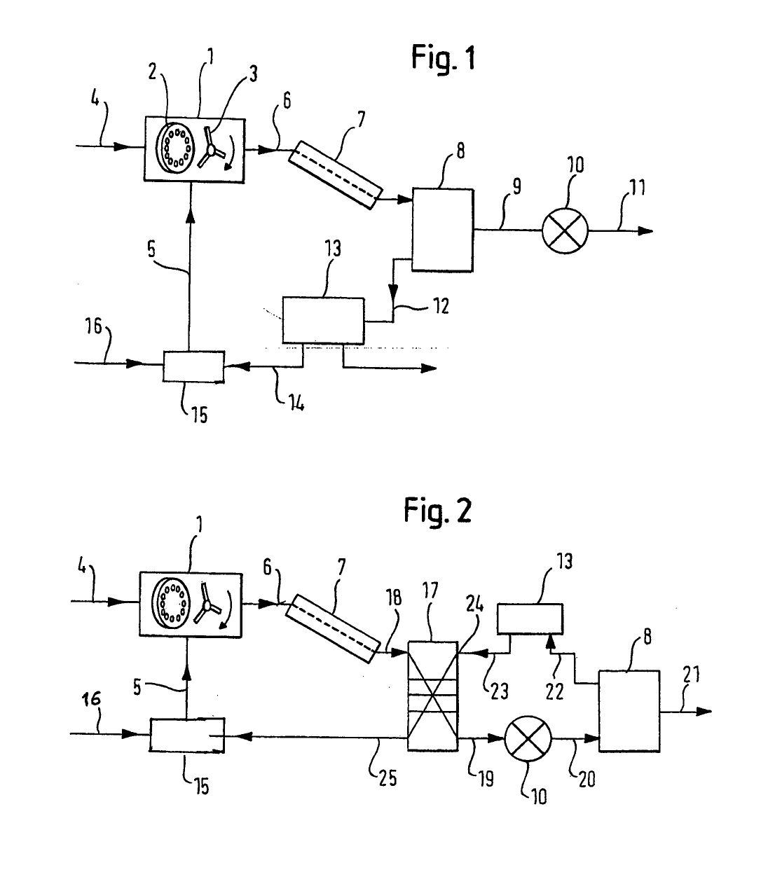

FIG. 1 is a view of a first embodiment without heat recovery for clearly illustrating the basic features of the method according to the invention;

FIG. 2 is a view of an embodiment of the method according to the invention in which the mixture of process fluid and granulate is directed into the separator via the pressure lock, thereby recovering the heat contained in it.

Shown in FIG. 1 is a particular embodiment of the method according to the invention in which the process chamber 1 is constituted by an underwater granulator which is known per se and which is formed in the usual manner by a perforated plate 2 and a cutting rotor 3 whose blades pass across said perforated plate 2, thereby chopping up the plastic strands, which are fed to the process chamber 1 as molten plastic via feed line 4, as they exit said perforated plate 2. This chopping process takes place in the process chamber 1 in a known manner using a process fluid supplied to the process chamber 1, which fluid is forced into the interior of said process chamber 1 via supply line 5. The process fluid is in particular water which fills the interior of the process chamber 1 at a temperature of more than 120° C. and a pressure of over 2 bar.

The granulate produced in the process chamber 1 will then be mixed with process fluid and the resulting mixture supplied to the cooling section 7 via feed line 6. In said cooling section 7, in which the pressure will be maintained, as much heat will then be withdrawn from the granulate as will be required for separating the granulate from the process fluid in the separator 8 which follows. Feed line 9 will then supply the granulate to the pressure lock 10 which is in particular formed as a rotary feeder and which will bring the supplied material down to ambient pressure so that it will be discharged from outlet 11 as a granulate ready for further processing.

The process fluid separated by the separator 8 will be supplied to the filtering and pumping unit 13 via feed line 12 where fine particles will be separated from the process fluid and the system pressure will be set to over 2 bar. Via feed line 14, the process fluid will then be introduced into the temperature setting unit 15 where, by means of the energy flow 16 (heating or cooling), the temperature of more than 120° C. will be set. The process fluid exiting the temperature setting unit 15 at a given pressure and temperature will then be supplied to the process chamber 1 via feed line 5.

Another embodiment illustrated in FIG. 2 for performing the method according to the invention includes a heat exchanger 17 for heat recovery which is incorporated in the overall design in the following manner.

The manner in which molten plastic is supplied via feed line 4 and the operating principle of the process chamber 1 are the same as outlined above with reference to FIG. 1 so that what has been set out with reference to FIG. 1 also applies here. As in the embodiment of FIG. 1, the mixture of process fluid and granulate will then be transported through the cooling section 7 and into the heat exchanger 17 which is merely symbolically shown in FIG. 2 and can in particular be implemented in the form of a known heat pump. The heat exchanger 17 receives the mixture via feed line 18 and forwards it to its outlet 19, at a low temperature, with the heat being used for a different purpose, as will be explained below. The mixture discharged from outlet 19 then passes through the pressure lock 10 whose outlet will then discharge the cooled-down mixture now at ambient pressure. From there, the mixture will be supplied to the separator 8 via feed line 20. At its outlet 21, the separator 8 will discharge the pure granulate at ambient pressure and at a lowered temperature for further processing. The separated process fluid will then be fed from the separator 8 to the filtering and pumping unit 13 via feed line 22, and said filtering and pumping unit 13 will supply purified process fluid to the inlet 24 of the heat exchanger 17 via feed line 23. Said inlet 24 will feed the process fluid to and through said heat exchanger 17 where said fluid will absorb the heat stored there and, thus heated up, will release said heat at the outlet 25 of said heat exchanger 17 for further use in that it supplies it to the temperature setting unit 15, much in the manner illustrated in FIG. 1, which will then ensure that hot and pressurized process fluid will be supplied to the process chamber 1 via feed line 5.

1. A method for granulating plastic having a softening temperature of above 120° C., comprising producing strands of molten plastic using a perforated plate and a process chamber containing a process fluid and including a chopping device, wherein the process chamber is configured to discharge a mixture of the process fluid and a granulate that is cooled down in a cooling section, wherein the process chamber is filled with the process fluid at a temperature of more than 120° C. and a pressure of over 2 bar, maintaining the mixture of the process fluid and the granulate under pressure as the mixture passes through the cooling section, passing the mixture through a pressure lock for reducing the pressure of the mixture to ambient pressure, and introducing the mixture into a separator in which said granulate is separated from said process fluid and discharged, wherein once said mixture of process fluid and the granulate has passed through said cooling section, the mixture is directed through a heat exchanger for heat recovery and then via the pressure lock into the separator at a temperature below the boiling point of the process fluid, wherein the separator is configured to output said granulate and return said process fluid to the process chamber via the heat exchanger.

2-3. (canceled)

4. The method of claim 1, wherein the heat exchanger comprises a heat pump for energy recovery.

5. The method of claim 1, wherein the apparatus comprises an underwater granulator as a chopping device.

6. The method of claim 1 wherein the plastic to be granulated comprises a polycarbonate, a polycarbonate blend, polystyrene, or low viscosity PET.

7. An apparatus for granulating plastic having a softening temperature of above 120° C., comprising a perforated plate and a process chamber for producing strands of molten plastic, the process chamber containing a process fluid and including a chopping device, wherein the process chamber is configured to discharge a mixture of the process fluid and a granulate that is cooled down in a cooling section, wherein the process chamber is filled with the process fluid at a temperature of more than 120° C. and a pressure of over 2 bar, wherein apparatus is configured to maintain the mixture of the process fluid and the granulate under pressure as the mixture passes through the cooling section, wherein the apparatus is configured to pass the mixture through a pressure lock for reducing the pressure of the mixture to ambient pressure, wherein the apparatus is configured to introduce the mixture into a separator in which said granulate is separated from said process fluid and discharged, and wherein the apparatus further comprises a heat exchanger for heat recovery such that once said mixture of process fluid and the granulate has passed through said cooling section, the mixture is directed through the heat exchanger for heat recovery and then via the pressure lock into the separator at a temperature below the boiling point of the process fluid, wherein the separator is configured to output said granulate and return said process fluid to the process chamber via the heat exchanger.

8. The apparatus of claim 7, wherein the heat exchanger comprises a heat pump for energy recovery.

9. The apparatus of claim 7, wherein the apparatus comprises an underwater granulator as a chopping device.

10. The apparatus of claim 7, wherein the plastic to be granulated comprises a polycarbonate, a polycarbonate blend, polystyrene, or low viscosity PET.
